(19) United States
(12) Patent Application Publication
(10) Pub. No.: US 2016/0026999 A1
(43) Pub. Date: Jan. 28, 2016

(54) TRACKING CARD USAGE USING DIGITAL WALLET

(71) Applicant: Bank of America Corporation, Charlotte, NC (US)

(72) Inventor: Manu Jacob Kurian, St. Louis, MO (US)

(21) Appl. No.: 14/339,144

(22) Filed: Jul. 23, 2014

(51) Int. Cl. G06Q 20/36; G06Q 20/40; G06Q 40/00

(52) U.S. Cl. CPC G06Q 20/36; G06Q 40/00; G06Q 20/40

(57) ABSTRACT

Embodiments of the present invention are directed to systems, apparatuses, methods, and computer program products for tracking card usage when using a digital wallet. The present invention is configured to enable a user to execute a transaction via a payment vehicle (e.g., a digital bank card, a digital card number, or the like) associated with a digital wallet application. Upon execution of the transaction, the present invention receives information associated with the transaction from a plurality of sources, such as a financial institution, a merchant, a third party payment processing entity, a third party software application, or the like. The present invention then processes the received transaction information and exports the transaction information to a budgeting application, which may or may not be integrated with the digital wallet application.

### BACKGROUND

In the technological age of today, transactions may be executed via an electronic payment credential such as a digital wallet. However, information associated with transactions is often generated from multiple sources, therefore resulting in scattered, unorganized, or incomplete transaction information. Therefore, a need exists for efficiently tracking and exporting transaction information, particularly for budgeting purposes.

### BRIEF SUMMARY

Embodiments of the present invention are directed to systems, apparatuses, methods, and computer program products for tracking card usage when using a digital wallet. The present invention is configured to enable a user to execute a transaction via a payment vehicle (e.g., a digital bank card, a digital card number, or the like) associated with a digital wallet application. Upon execution of the transaction, the present invention receives information associated with the transaction from a plurality of sources, such as a financial institution, a merchant, a third party payment processing entity, a third party software application, or the like. The present invention then processes the received transaction information and exports the transaction information to a budgeting application, which may or may not be integrated with the digital wallet application.

In some embodiments, a mobile device for tracking payment credential usage using a digital wallet is provided. The mobile device comprises: a memory; a processor; and a digital wallet module stored in the memory, when executed by the processor, causes the processor to: receive a request from a user to perform a transaction; in response to the request, conduct the transaction using a payment credential associated with the digital wallet; determine transaction information associated with the conducted transaction; and export, from the digital wallet to a budgeting application, some or all of the determined transaction information.

In some embodiments, the digital wallet module when executed further causes the processor to: determine second transaction information associated with a second conducted transaction; and export, from the digital wallet to a budgeting application, some or all of the determined second transaction information.

In some embodiments, the exported transaction information comprises a transaction amount associated with the conducted transaction.

In some embodiments, the exported transaction information comprises a product category code indicating a category of a product purchased by the conducted transaction.

In some embodiments, the digital wallet module when executed further causes the processor to: determine the second transaction information from a second transaction conducted by the digital wallet using a second payment credential.

In some embodiments, the digital wallet module when executed further causes the processor to: determine the second transaction information from a second transaction conducted by the digital wallet using the payment credential.

In some embodiments, the digital wallet module when executed further causes the processor to: determine the second transaction information from a second transaction conducted by a second digital wallet using a second payment credential.

In some embodiments, the digital wallet module when executed further causes the processor to: receive authorization from the user for the digital wallet to be granted access to the second digital wallet for the purpose of determining transaction information from transactions conducted by the second digital wallet.

In some embodiments, the digital wallet module when executed further causes the processor to: receive authorization from the user for the digital wallet to be granted access to transaction information from transactions conducted using a second payment credential.

In some embodiments, the second payment credential is associated with the digital wallet.

In some embodiments, the second payment credential is associated with a second digital wallet.

In some embodiments, the digital wallet module when executed further causes the processor to: receive authorization from the user for the digital wallet to export transaction information from the digital wallet to the budgeting application.

In some embodiments, the digital wallet module requires authentication of the request from the user to perform the transaction, wherein authentication comprises at least one of user authentication or confirmation of sufficient funds in an account associated with the payment credential.

In some embodiments, transaction information is received by the digital wallet module from a plurality of sources, wherein the transaction information received from the plurality of sources comprises at least one of information inputted by the user, information received from a merchant, distributor, or vendor, information received from one or more financial institutions, or information received from a third party payment processing entity.

In some embodiments, exporting some or all of the determined transaction information comprises generating a report comprising the determined transaction information.

In some embodiments, the budgeting application is integrated with the digital wallet module.

In some embodiments, the payment credential comprises at least one of a bank card, a credit card, a debit card, a travel card, a temporary card, or a token associated with a financial account.

In some embodiments, the digital wallet module when executed further causes the processor to: generate an image of a check, wherein the image of the check is generated using the determined transaction information; and enable the user to select and use the image of the check as a second payment credential for a second transaction.

In some embodiments, a method for reducing digital wallet exposure is provided, whereby a processor determines a potential exposure of a payment credential in a digital wallet and initiates exposure reduction measures to reduce potential exposure to other payment credentials in the digital wallet. The method comprises: receiving a request from a user to perform a transaction; in response to the request, conducting the transaction using a payment credential associated with the digital wallet; determining transaction information associated with the conducted transaction; and exporting, from the digital wallet to a budgeting application, some or all of the determined transaction information.

In some embodiments, a computer program product for reducing digital wallet exposure is provided, whereby the computer program product determines a potential exposure of a payment credential in a digital wallet and initiates exposure reduction measures to reduce potential exposure to other payment credentials in the digital wallet. The computer program product comprises a non-transitory computer-readable medium comprising code causing a first apparatus to: receive a request from a user to perform a transaction; in response to the request, conduct the transaction using a payment credential associated with the digital wallet; determine transaction information associated with the conducted transaction; and export, from the digital wallet to a budgeting application, some or all of the determined transaction information.

The systems, apparatuses, methods, and computer program products of the present invention provide many benefits. First, by compiling transaction information from multiple sources, accuracy and completeness of transaction information is increased. Second, processing and exporting of transaction information to a budgeting application greatly reduces the amount of time required to retrieve and process transaction information from multiple sources. Additionally, exporting the transaction information enables the user to more quickly and accurately budget based on the transaction information.

### BRIEF DESCRIPTION OF THE DRAWINGS

Having thus described embodiments of the invention in general terms, reference will now be made to the accompanying drawings, where:

FIG. 1 is an exemplary process flow 100 for tracking and exporting transaction information for budgeting purposes, in accordance with embodiments of the present invention;

FIG. 2 is an exemplary user interface 200 for tracking and exporting transaction information for budgeting purposes, in accordance with embodiments of the present invention; and

FIG. 3 is an exemplary system environment 300 for implementing the tracking and exporting transaction information for budgeting purposes, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In other embodiments, an “entity” may not be a financial institution.

In some embodiments, a “user” as used herein is a mobile banking customer, a digital wallet customer, a person who holds an account associated with the entity, a merchant, a third party transaction or payment processing specialist, or the like. In other embodiments, the user is an associate, an agent, a specialist, an account manager, a teller, or the like associated with the entity. In alternative embodiments, the user may not be associated with the entity and instead may be associated with a third party entity, such as a third party document processing firm, or the like.

In accordance with embodiments of the invention, the term “financial transaction” or “transaction” refers to any transaction involving directly or indirectly the movement of monetary funds through traditional paper transaction processing systems (i.e. paper check processing) or through electronic transaction processing systems. Typical financial transactions include point of sale (POS) transactions, automated teller machine (ATM) transactions, internet transactions, electronic funds transfers (EFT) between accounts, transactions with a financial institution teller, personal checks, etc. When discussing that transactions are evaluated it could mean that the transaction has already occurred, is in the processing of occurring or being processed, or it has yet to be processed by one or more financial institutions. In some embodiments of the invention the transaction may be a customer account event, such as but not limited to the customer changing a password, ordering new checks, adding new accounts, opening new accounts, etc.

Embodiments of the present invention are directed to systems, apparatuses, methods, and computer program products for tracking card usage when using a digital wallet. The present invention is configured to enable a user to execute a transaction via a payment vehicle (e.g., a digital bank card, a digital card number, or the like) associated with a digital wallet application. Upon execution of the transaction, the present invention receives information associated with the transaction from a plurality of sources, such as a financial institution, a merchant, a third party payment processing entity, a third party software application, or the like. The present invention then processes the received transaction information and exports the transaction information to a budgeting application, which may or may not be integrated with the digital wallet application.

The systems, apparatuses, methods, and computer program products of the present invention address a particular problem. Specifically, a problem arises when a user executes a transaction using a digital wallet. After executing the transaction, information associated with the transaction is generated, transmitted, received, and/or retrieved by a plurality of parties involved in the transaction. For example, when a customer makes a payment to a merchant, the payment (as well as information associated with the payment) is typically communicated between a financial institution associated with the customer, a financial institution associated with the merchant, a third party payment processing entity, a distributor or vendor, or the like. Therefore, execution of the payment may generate payment information in a plurality of different locations, and the generated payment information is not reconciled, aggregated, or processed as collective payment information. Instead, the generated payment information is unorganized, which makes processing of the payment information time consuming. Furthermore, with the payment information unorganized, the customer has no way to use collectively processed payment information for budgeting purposes, and budgeting becomes a time- and cost-inefficient process.

The systems, apparatuses, methods, and computer program products of the present invention provide many benefits. First, by compiling transaction information from multiple sources, accuracy and completeness of transaction information is increased. Second, processing and exporting of transaction information to a budgeting application greatly reduces the amount of time required to retrieve and process transaction information from multiple sources. Additionally, exporting the transaction information enables the user to more quickly and accurately budget based on the transaction information.

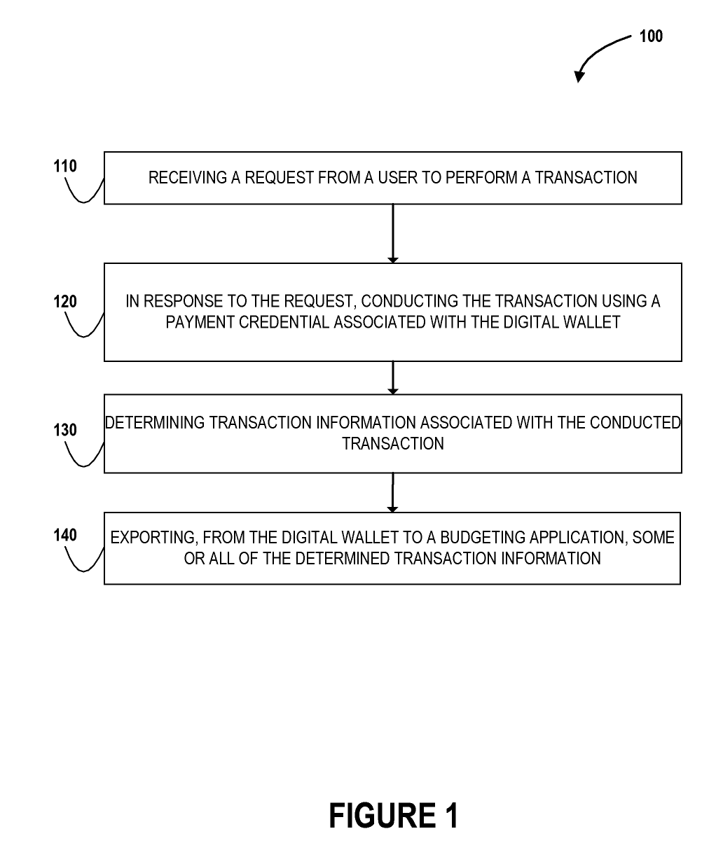

Referring now to the Figures, FIG. 1 illustrates an exemplary process flow 100 for tracking and exporting transaction information for budgeting purposes. At block 110, the process includes receiving a request from a user to perform a transaction. At block 120, the process includes, in response to the request, conducting the transaction using a payment credential associated with the digital wallet. At block 130, the process includes determining transaction information associated with the conducted transaction. At block 140, the process includes exporting, from the digital wallet to a budgeting application, some or all of the determined transaction information.

When the user wishes to perform a transaction (e.g., make a payment in exchange for goods and/or services, make a withdrawal or deposit, inquire in regards to an account balance, or the like), the user may utilize a digital wallet. A user may have one or more digital wallets on the user's payment device. The digital wallets may be associated specifically with the user's financial institution, or in other embodiments may be associated with a specific merchant, group of merchants, or other third parties. The user may associate one or more user accounts (e.g., from the same institution or from multiple institutions) with the one or more digital wallets. The digital wallet may be utilized in a number of different ways. For example, the digital wallet may be a device digital wallet, a cloud digital wallet, an e-commerce digital wallet, or another type of digital wallet. The digital wallet and information withheld therein is typically modifiable by the user.

Typically embodied as a software application installed on a mobile device associated with the user, the digital wallet may be associated with an account held by the user so that the user may utilize the digital wallet for providing payment or executing other transactions. The digital wallet may include a plurality of payment credentials such as credit cards, debit cards, an account number, a token associated with an account, or the like. The payment credentials are typically stored electronically on the digital wallet, but may also serve as a pointer to an account associated with the payment credential. The digital wallet may also be associated with or installed on another computing device such as a laptop, desktop, tablet, wearable device, or the like.

For example, instead of the user being required to present a physical card to a merchant during a purchase transaction, the user may utilize a payment credential associated with the user's card via the digital wallet, which is accessed via a mobile device. In some embodiments, the payment credential is associated with the entity. In other embodiments, the payment credential is associated with a third party payment provider. In this way, the user utilizes one digital wallet that supports multiple payment credentials associated with various payment providers.

First, the user utilizes the digital wallet to initiate a request to execute and/or perform a transaction. The request typically includes information associated with the transaction request, such as a payment or transaction amount. The user may denote, select, or input a type of transaction (e.g., a purchase transaction, a withdrawal, a funds transfer, or the like), a transaction recipient, a transaction amount, a memo or notes associated with the transaction, as purchase category code to indicate a category of a product purchased by the user during an executed transaction, or other information required and/or helpful for execution and appropriate recordation of the transaction. For example, the user may select to initiate a request to transfer funds between two accounts associated with different payment providers via the digital wallet. In some embodiments, the digital wallet includes a predetermined form for initiating a request, wherein the predetermined form includes a plurality of information fields presented to the user via an interface for information entry.

Typically, the user follows a series of menus via an interface associated with the digital wallet to select a payment credential to use for executing the transaction. The user may select a card, such as a checking card, a debit card, a credit card, a temporary card, a gift card, or a token, either permanent or temporary, associated with an account held by the user, a store credit, or another payment credential. The payment credential is associated with an account associated with the user, or another individual or entity, so that when the payment credential is provided during execution or conduction of the transaction, funds may be transferred from an account associated with the payment credential to an account associated with the transaction recipient. The account associated with the payment credential may include a checking account, a savings account, an investment account, a rewards card account, a gift card account, or a virtual currency account, or another type of financial account.

Upon selection of the payment credential, the request to perform or execute the transaction is authenticated. Authentication of the request may include determining that the account associated with the selected payment credential contains at least an amount of funds associated with the purchase transaction. Authentication of the request may also include authentication of the information associated with the request. For example, the account associated with the transaction recipient may be authenticated or verified so as to ensure that a transfer of funds between the account associated with the payment credential and the account associated with the transaction recipient is secure. Authentication of the request may occur prior to or substantially simultaneously to initiation of the request, or execution of the transaction.

The digital wallet is specifically configured to track when the user selects a card (e.g., a bank card, a credit card, a debit card, a gift card, a temporary card, a travel card, or the like), or another payment credential for executing or conducting the transaction. In this way, the digital wallet is configured to track the transaction (and any subsequent transactions) executed or conducted using the card (or another selected payment credential). The digital wallet may track the transaction prior to executing or conducting the transaction (e.g., substantially simultaneously to initiation of the transaction request, or after receiving the request from the user), substantially simultaneously to executing or conducting the transaction, or after execution or conduction of the transaction. Thus, when a transaction is executed or conducted via the digital wallet, and in particular via use of a card, transaction information is tracked by the digital wallet.

The digital wallet is therefore configured to retrieve and/or receive information associated with the transaction based on the user's selection of a card as a payment credential via the digital wallet. This transaction information may include information associated with the transaction request as described herein, financial institution information associated with the user and/or the transaction recipient, account information (e.g., an account number, a routing number, a card number, or the like) associated with the user and/or the transaction recipient, contact information (e.g., a name, a phone number, an address, an email address, or the like) associated with the user and/or the transaction recipient, a transaction amount, location information (e.g., an address, global positioning system (GPS) coordinates, an Internet Protocol (IP) address, longitude and latitude, or the like) associated with the transaction or a merchant location, or other information.

Transaction information may be retrieved and/or received from a plurality of sources. For example, the digital wallet may retrieve and/or receive information from a merchant after a payment has been received, a third party payment processor after a payment has been processed, one or more financial institutions, a distributor or vendor, or another source.

Once retrieved and/or received, the transaction information is recorded and/or stored by the digital wallet. The transaction information may be stored in a database or datastore associated with the digital wallet, or in another memory location. Typically the digital wallet is enabled to access the transaction information so that the transaction information may be displayed, manipulated, processed, or modified via the smartphone or other device on which the digital wallet operates.

The digital wallet further enables the user to execute or conduct the transaction. In some embodiments, executing the transaction comprises facilitating a transfer of funds between accounts (e.g., a transfer of funds from an account associated with the payment credential selected by the user to an account associated with a transaction recipient), a withdrawal, a deposit, or the like. In other embodiments, executing the transaction comprises executing another action or “account event.” Account events comprise any interactions that an individual, such as a customer or unauthorized user may have with an account of the customer. The account may be a financial account, a digital wallet, or a customer profile account, which stores customer information, such as addresses, telephone numbers or the like. The interactions with the accounts may be direct or indirect. Indirect interaction may include an online or mobile banking session, in which the individual may not specifically interact with accounts but performs some other financial institution-related activity. As such, account event data may include, but is not limited to, data related to changing account authorization credentials, such as a user identifier and/or password; ordering/re-ordering financial products, such as checks, debit/credit card; changing payment credentials; linking one account to one or more other accounts; opening and/or closing accounts; addition and/or deletion of account users; changing customer or account-specific personal information, such as mailing address; balance inquiries and the like. In some embodiments the account events may be “non-monetary events” such that monetary events are not related to the account events, however, in some embodiments the account events may include a monetary component.

In some embodiments, the digital wallet enables the user to request, perform, execute, and/or conduct a plurality of transactions. When multiple transactions (e.g., a first transaction and a second transaction) are to be executed via the digital wallet, the digital wallet may treat each of the multiple transactions in the same way as disclosed herein.

After execution or conduction of the transaction, transaction information may be retrieved and/or received from the plurality of sources by the digital wallet. The digital wallet then processes the transaction information. Processing the transaction information includes determining transaction information associated with the conducted transaction. For example, the digital wallet compiles, organizes, filters, sorts, and/or stores transaction information received from the plurality of sources. Therefore, the digital wallet determines which pieces of received transaction information are relevant to the executed transaction, thus ensuring that relevant transaction information is associated with the transaction.

After processing, the digital wallet is further configured to export the transaction information. In some embodiments, the digital wallet exports the transaction information by transmitting the transaction information from the digital wallet to a budgeting application. In other embodiments, the digital wallet exports the transaction information by transmitting the transaction information from the digital wallet to another application, apparatus, or device. Exporting the transaction information may further include generating a report that includes the transaction information, as well as a transaction history or a summary of account activity associated with the usage of the user-selected payment credential.

In some embodiments, the budgeting application is associated with the entity. The budgeting application may be integrated with the digital wallet so that the user may access the transaction information via the digital wallet interface. In other embodiments, the budgeting application is not associated with the entity and is therefore associated with a third party.

The purpose of collecting, processing, and exporting transaction information is to help the user manage an amount of funds held in an account associated with the user-selected payment credential (e.g., the card). Further, by enabling the user to access transaction information via the digital wallet, the user is able to more appropriately manage spending associated with the user-selected payment credential. The exported transaction information is typically displayed to the user and may include a remaining balance in the account associated with the used payment credential, transaction information, a payment history, an account summary, account information, contact information, user preferences, or other information useful for managing funds.

The digital wallet further enables the user to pay with a check via the digital wallet. Upon user selection of a check transaction payment type, the digital wallet is configured to generate an image of a check via the user's smartphone or other device on which the digital wallet is accessed and operated. For example, the user typically inputs information associated with a requested transaction, such as a transaction amount, a payee, a memo, a time and date, an electronic signature, contact information, or the like. The digital wallet then processes the inputted information associated with a requested transaction and generates a check image based on the inputted information associated with the requested transaction. The user presents the generated check image to a merchant for payment. The merchant then captures (e.g., scans, receives, or the like) the check image for payment processing, and the transaction is executed. The check image may also be transmitted to the merchant via a message (e.g., an email, a text message, a notification, or the like).

In some embodiments, the user is required to provide an authentication credential to the digital wallet in order to view, modify, delete, or add information associated with the transaction. Authentication may also be required by the digital wallet at various other times during operation, such as when selecting a payment credential or logging in to the digital wallet. The digital wallet prompts typically the user for at least one authentication credential (e.g., a password, a passcode, a personal identification number (PIN), an answer to a security question, a biometric input, voice recognition or verification, readable indicia, a gesture, a user input, or the like). The digital wallet receives the at least one authentication credential and compares the received at least one authentication credential to a plurality of authentication credentials associated with authentication of the user. The digital wallet determines at least a partial match between the at least one authentication credential and the plurality of authentication credentials associated with authentication. Based on determining a match, the digital wallet authenticates the user and enables the user to access, view, modify, delete, or add information associated with the transaction, select a payment credential, and/or execute the transaction. If no match is determined between the at least one authentication credential and the plurality of authentication credentials associated with authentication of the user, the digital wallet may prompt the user for another authentication credential or deny the user from execution of an action (e.g., accessing or modifying information). In other embodiments, dual or two-factor verification is employed by the digital wallet.

The digital wallet may further include an association with a second digital wallet so that the second digital wallet may be accessed by the user via a first digital wallet (e.g., the digital wallet). For example, the user may use the digital wallet associated with the entity to access a second digital wallet associated with a third party payment provider. In this way, the digital wallet of the present invention is configured to support integration of multiple digital wallets (or other payment vehicles) associated with various third parties into the digital wallet. User authentication (perhaps dual or two-factor verification) may be required to access the second digital wallet within the digital wallet. Multiple digital wallets may be associated with one another using a third party application programming interface (API), an open standard of authentication (e.g., OAuth), security assertion markup language (SAML), or other means of secure integration.

The digital wallet of the present invention further includes support for handicapped individuals. For example, the digital wallet includes speech-to-text and text-to-speech input means for seeing-impaired individuals, text display for hearing impaired individuals, or the like. The digital wallet also includes a repetitive use feature that tracks repetitive inputs or entries and provides to the user an option to select a most recently-used or a most frequently-used transaction, input, selection, or the like. The digital wallet is configured to support multiple languages and includes a comprehensive list of user preferences and/or settings to create an optimized user experience. Support for minor users (e.g., users under the age of eighteen) is included in the digital wallet. For example, a user may have access to parental controls via the digital wallet to control digital wallet usage of the user's child, who has access to the digital wallet (or a second digital wallet) via the same or a different mobile device. Additionally, the digital wallet supports scheduled events, transactions, or the like configured by the user or the entity (e.g., a recurring monthly payment). The digital wallet is configured to search for and flag keywords, which are analyzed for insider threat detection as well as detection of any fraudulent activity. A lock function or another type of security means may inhibit the user from executing any commands, transactions, or selections if the user is using an unauthorized or unregistered device to access the digital wallets and its associated content. Therefore, the user may be required to authorize and/or register a device before being enabled to access the digital wallet via the device.

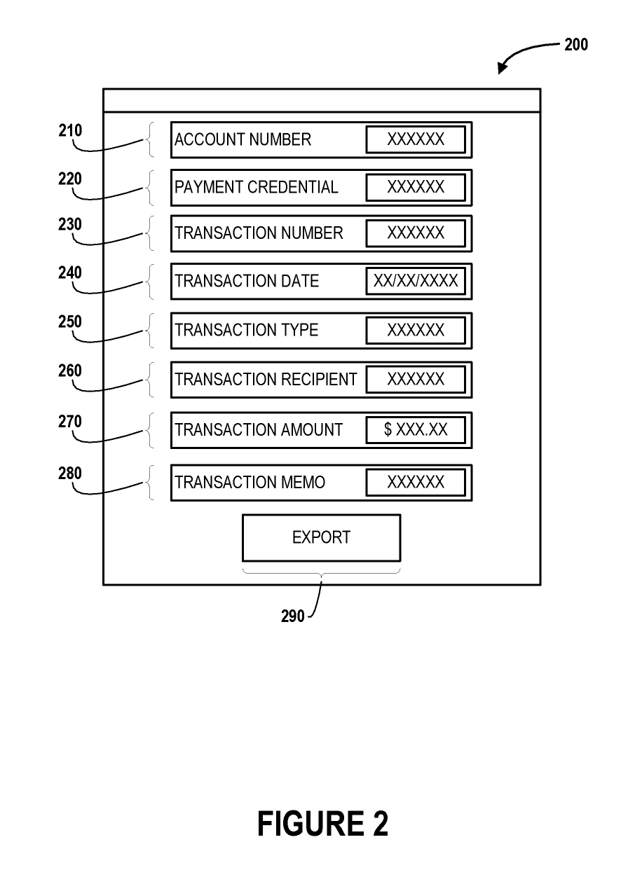

FIG. 2 illustrates an exemplary user interface 200 for tracking and exporting transaction information for budgeting purposes. The interface 200 includes a plurality of information fields (e.g., text boxes, selection menus, graphs, or the like) configured to display transaction information received from a plurality of sources during processing of the transaction information. The transaction information includes information associated with the transaction determined by the digital wallet to be relevant or important, such as an account number 210 of an account associated with a selected payment credential 220. The payment credential 220 is typically selected for each transaction, but the user may also set a preferred payment credential to use when executing all transactions. The transaction information may also include a transaction number 230, a transaction date 240, a transaction type 250 (e.g., a purchase, a withdrawal, a deposit, or the like), a transaction recipient 260 (e.g., a merchant), a transaction amount 270, and a transaction memo 280 (e.g., notes and comments associated with the transaction). The user, upon review of the transaction information, may choose to export 290 the transaction information to a budgeting application so that the user may use the transaction information to better manage funds and finances. The user may access the exported transaction information via the budgeting application, which may be associated with the digital wallet. Therefore the user uses the digital wallet to operate the budgeting application.

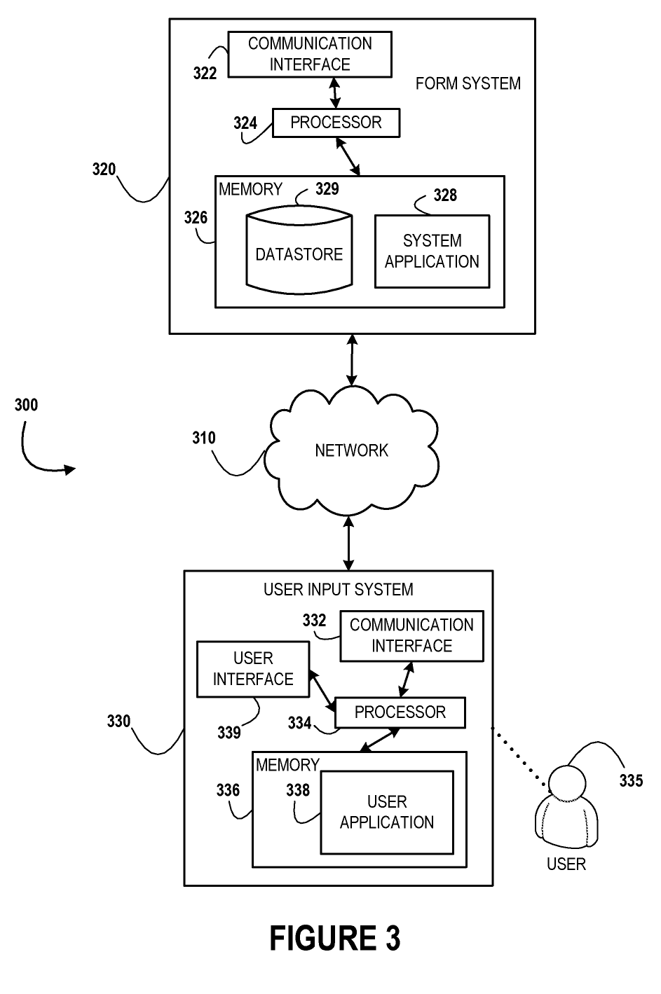

FIG. 3 is an exemplary block diagram illustrating technical components of a system 300 for tracking and exporting transaction information for budgeting purposes as described in the process flow 100 and as described in FIG. 1, as well as the exemplary interface 200 as illustrated in FIG. 2. As illustrated, the system environment 300 includes a network 310, a tracking system 320, and a user input system 330.

As shown in FIG. 3, the tracking system 320 and the user input system 330 are each operatively and selectively connected to the network 310, which may include one or more separate networks. In addition, the network 310 may include a telecommunication network, local area network (LAN), a wide area network (WAN), and/or a global area network (GAN), such as the Internet. It will also be understood that the network 310 is secure and may also include wireless and/or wireline and/or optical interconnection technology.

FIG. 3 also illustrates a tracking system 320, in accordance with an embodiment of the present invention. The tracking system 320 may refer to the “apparatus” or “system” described herein. The tracking system 320 may include any computerized apparatus that can be configured to perform any one or more of the functions of the tracking system 320 described and/or contemplated herein. In accordance with some embodiments, for example, the tracking system 320 may include a computer network, an engine, a platform, a server, a database system, a front end system, a back end system, a personal computer system, and/or the like. Therefore, the tracking system 320 may be a server managed by the entity. The tracking system 320 may be located at the facility associated with the entity or remotely from the facility associated with the entity. In some embodiments, such as the one illustrated in FIG. 3, the tracking system 320 includes a communication interface 322, a processor 324, and a memory 326, which includes a system application 328 and a datastore 329 stored therein. As shown, the communication interface 322 is operatively and selectively connected to the processor 324, which is operatively and selectively connected to the memory 326.

It will be understood that the system application 328 may be configured to implement any one or more portions of the various user interfaces and/or process flow described herein. Specifically, the system application 328 may execute the process flow described in FIG. 1. The system application 328 may interact with the user application 338. For example, the system application 328 may initiate presentation of a form on a user interface 339 or receive information or commands from the user interface 339 via the user application 338. It will also be understood that, in some embodiments, the memory includes other applications. It will also be understood that, in some embodiments, the system application 328 is configured to communicate with the datastore 329, the user input system 330, or the like.

It will be further understood that, in some embodiments, the system application 328 includes computer-executable program code portions for instructing the processor 324 to perform any one or more of the functions of the system application 328 described and/or contemplated herein. In some embodiments, the system application 328 may include and/or use one or more network and/or system communication protocols.

In addition to the system application 328, the memory 326 also includes the datastore 329. As used herein, the datastore 329 may be one or more distinct and/or remote datastores. In some embodiments, the datastore 329 is not located within the tracking system 320 and is instead located remotely from the tracking system 320. In some embodiments, the datastore 329 stores information or data described herein.

It will be understood that the datastore 329 may include any one or more storage devices, including, but not limited to, datastores, databases, repositories, and/or any of the other storage devices typically associated with a computer system. It will also be understood that the datastore 329 may store information in any known way, such as, for example, by using one or more computer codes and/or languages, alphanumeric character strings, data sets, figures, tables, charts, links, documents, and/or the like. Further, in some embodiments, the datastore 329 may include information associated with one or more applications, such as, for example, the system application 328, information associated with a customer or a customer's financial account or another type of account, a transaction or payment, or the like. It will also be understood that, in some embodiments, the datastore 329 provides a substantially real-time representation of the information stored therein, so that, for example, when the processor 324 accesses the datastore 329, the information stored therein is current or substantially current.

It will be understood that the embodiment of the system environment 300 illustrated in FIG. 3 is exemplary and that other embodiments may vary. As another example, in some embodiments, the tracking system 320 includes more, less, or different components. As another example, in some embodiments, some or all of the portions of the system environment 300 may be combined into a single portion. Likewise, in some embodiments, some or all of the portions of the tracking system 320 may be separated into two or more distinct portions.

In addition, the various portions of the system environment 300 may be maintained for and/or by the same or separate parties. It will also be understood that the tracking system 320 may include and/or implement any embodiment of the present invention described and/or contemplated herein. For example, in some embodiments, the tracking system 320 is configured to implement any one or more of the embodiments of the process flows described and/or contemplated herein in connection any process flow described herein. Additionally, the tracking system 320 or the user input system 330 is configured to initiate presentation of any of the user interfaces described herein.

The user input system 330 may include any computerized apparatus that can be configured to perform any one or more of the functions of the user input system 330 described and/or contemplated herein. For example, the user 335 may use the user input system 330 to transmit and/or receive information or commands to and from the tracking system 320. In some embodiments, for example, the user input system 330 may include a personal computer system (e.g. a non-mobile or non-portable computing system, or the like), a mobile computing device, a personal digital assistant, a mobile phone, a tablet computing device, a network device, a wearable computing device, a sensor, and/or the like. As illustrated in FIG. 3, in accordance with some embodiments of the present invention, the user input system 330 includes a communication interface 332, a processor 334, a memory 336 having a user application 338 stored therein, and a user interface 339. In such embodiments, the communication interface 332 is operatively and selectively connected to the processor 334, which is operatively and selectively connected to the user interface 339 and the memory 336. In some embodiments, the user 335 may use the user application 338 to execute processes described with respect to the process flow and interfaces described herein.

Each communication interface described herein, including the communication interface 332, generally includes hardware, and, in some instances, software, that enables the user input system 330, to transport, send, receive, and/or otherwise communicate information to and/or from the communication interface of one or more other systems on the network 310. For example, the communication interface 332 of the user input system 330 may include a wireless transceiver, modem, server, electrical connection, and/or other electronic device that operatively connects the user input system 330 to another system such as the tracking system 320. The wireless transceiver may include a radio circuit to enable wireless transmission and reception of information. Each processor described herein, including the processor 334, generally includes circuitry for implementing the audio, visual, and/or logic functions of the user input system 330. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 338 of the memory 336 of the user input system 330.

Each memory device described herein, including the memory 336 for storing the user application 338 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the tracking system 320 or the user input system 330 in which it resides to implement the functions of the tracking system 320 or the user input system 430.

As shown in FIG. 3, the memory 336 includes the user application 338. In some embodiments, the user application 338 includes an interface for communicating with, navigating, controlling, configuring, and/or using the user input system 330. In some embodiments, the user application 338 includes computer-executable program code portions for instructing the processor 334 to perform one or more of the functions of the user application 338 described and/or contemplated herein. In some embodiments, the user application 338 may include and/or use one or more network and/or system communication protocols.

Also shown in FIG. 3 is the user interface 339. In some embodiments, the user interface 339 includes one or more output devices, such as a display and/or speaker, for presenting information to the user 335. In some embodiments, the user interface 339 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user 335. In some embodiments, the user interface 339 includes the input and display devices of a mobile device, which are operable to receive and display information.

Also shown in FIG. 3 is a user 335 of the user input system 330. The user input system 330 may be any computing device. The user 335 may be a person who uses the user input system 330 to execute a user application 338. The user application 338 may be an application to communicate with the tracking system 320, perform a transaction, input information onto a user interface presented on the user input system 330, receive and/or transmit information, the like. The user application 338 and/or the system application 328 may incorporate one or more parts of any process flow described herein.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A mobile device for tracking payment credential usage using a digital wallet, the apparatus comprising:
a memory;
a processor; and
a digital wallet module stored in the memory, when executed by the processor, causes the processor to:
receive a request from a user to perform a transaction;
in response to the request, conduct the transaction using a payment credential associated with the digital wallet;
determine transaction information associated with the conducted transaction; and
export, from the digital wallet to a budgeting application, some or all of the determined transaction information.

2. The mobile device of claim 1, wherein the digital wallet module when executed further causes the processor to:
determine second transaction information associated with a second conducted transaction; and
export, from the digital wallet to a budgeting application, some or all of the determined second transaction information.

3. The mobile device of claim 1, wherein the exported transaction information comprises a transaction amount associated with the conducted transaction.

4. The mobile device of claim 1, wherein the exported transaction information comprises a product category code indicating a category of a product purchased by the conducted transaction.

5. The mobile device of claim 2, wherein the digital wallet module when executed further causes the processor to:
determine the second transaction information from a second transaction conducted by the digital wallet using a second payment credential.

6. The mobile device of claim 2, wherein the digital wallet module when executed further causes the processor to:
determine the second transaction information from a second transaction conducted by the digital wallet using the payment credential.

7. The mobile device of claim 2, wherein the digital wallet module when executed further causes the processor to:
determine the second transaction information from a second transaction conducted by a second digital wallet using a second payment credential.

8. The mobile device of claim 7, wherein the digital wallet module when executed further causes the processor to:
receive authorization from the user for the digital wallet to be granted access to the second digital wallet for the purpose of determining transaction information from transactions conducted by the second digital wallet.

9. The mobile device of claim 1, wherein the digital wallet module when executed further causes the processor to:
receive authorization from the user for the digital wallet to be granted access to transaction information from transactions conducted using a second payment credential.

10. The mobile device of claim 9, wherein the second payment credential is associated with the digital wallet.

11. The mobile device of claim 9, wherein the second payment credential is associated with a second digital wallet.

12. The mobile device of claim 1, wherein the digital wallet module when executed further causes the processor to:
receive authorization from the user for the digital wallet to export transaction information from the digital wallet to the budgeting application.

13. The mobile device of claim 1, wherein the digital wallet module requires authentication of the request from the user to perform the transaction, wherein authentication comprises at least one of user authentication or confirmation of sufficient funds in an account associated with the payment credential.

14. The mobile device of claim 1, wherein transaction information is received by the digital wallet module from a plurality of sources, wherein the transaction information received from the plurality of sources comprises at least one of information inputted by the user, information received from a merchant, distributor, or vendor, information received from one or more financial institutions, or information received from a third party payment processing entity.

15. The mobile device of claim 1, wherein exporting some or all of the determined transaction information comprises generating a report comprising the determined transaction information.

16. The mobile device of claim 1, wherein the budgeting application is integrated with the digital wallet module.

17. The mobile device of claim 1, wherein the payment credential comprises at least one of a bank card, a credit card, a debit card, a travel card, a temporary card, or a token associated with a financial account.

18. The mobile device of claim 1, wherein the digital wallet module when executed further causes the processor to:
generate an image of a check, wherein the image of the check is generated using the determined transaction information; and
enable the user to select and use the image of the check as a second payment credential for a second transaction.

19. A method for reducing digital wallet exposure, whereby a processor determines a potential exposure of a payment credential in a digital wallet and initiates exposure reduction measures to reduce potential exposure to other payment credentials in the digital wallet, the method comprising:
receiving a request from a user to perform a transaction;
in response to the request, conducting the transaction using a payment credential associated with the digital wallet;
determining transaction information associated with the conducted transaction; and
exporting, from the digital wallet to a budgeting application, some or all of the determined transaction information.

20. A computer program product for reducing digital wallet exposure, whereby the computer program product determines a potential exposure of a payment credential in a digital wallet and initiates exposure reduction measures to reduce potential exposure to other payment credentials in the digital wallet, the computer program product comprising a non-transitory computer-readable medium comprising code causing a first apparatus to:
receive a request from a user to perform a transaction;
in response to the request, conduct the transaction using a payment credential associated with the digital wallet;
determine transaction information associated with the conducted transaction; and
export, from the digital wallet to a budgeting application, some or all of the determined transaction information.
